(19) United States
(12) Patent Application Publication
(10) Pub. No.: US 2003/0140233 A1
(43) Pub. Date: Jul. 24, 2003

(54) Method and apparatus for facilitating low-cost and scalable digital identification authentication

(76) Inventor: Vipin Samar, Cupertino, CA (US)

Correspondence Address: PARK, VAUGHAN & FLEMING LLP, 508 SECOND STREET, SUITE 201, DAVIS, CA, 95616, US

(21) Appl. No.: 10/054,574

(22) Filed: Jan. 22, 2002

(51) Int. Cl. H04K 1/00

(52) U.S. Cl. 713/186

(57) ABSTRACT

One embodiment of the present invention provides a system for authenticating and individual's identity. The system operates by receiving an identification credential from the individual, such as an ID card, that contains information about the individual including biometric data. This ID card is signed with a private key. The system also receives a biometric sample from the individual, such as a finger print. The system validates the identification credential with the corresponding public key and compares the biometric data with the biometric sample. If the difference between the data and the sample is below a predetermined threshold, the system reports a positive identification. Otherwise, the system reports a negative identification. Note that the system operates solely on information contained within the identification credential and without requiring a connection to a network or a database.

### BACKGROUND

1. Field of the Invention

The present invention relates to providing security and authentication. More specifically, the present invention relates to a method and an apparatus for authenticating the identity of an individual with an identification credential.

2. Related Art

In light of recent events, the need for a scalable, cost-effective authentication solution has risen to the top of many agencies' and corporations' priority lists. However, current systems for performing authentication, which can be difficult to implement and very expensive in terms of resources, are inadequate in many ways.

The problem of physically identifying a person has typically been solved through verifying either some physical attributes of the person, or by verifying an identification card issued to the person by some authority, such as a driver's license or a passport. Many problems exist, however, with ID-based authentication. First and foremost, ID cards are becoming increasingly easier to counterfeit. As technology advances at a rapid pace, ID cards are becoming increasingly more complex in order to deter counterfeiting. Holograms and watermarks are now commonly incorporated into ID cards. At the same time, the rapid advances in technology make it easier to produce counterfeit versions of complex ID cards that are virtually indistinguishable from authentic ID cards. Another problem with simple ID-based authentication is the inherently subjective nature of the human-based authentication process. As long as a human is performing the authentication, the determination will be subjective.

Biometric authentication systems solve the counterfeiting problem to a certain extent but create false positives, are error prone, and carry a high cost because of the infrastructure required to perform the biometric authentication. For example, this infrastructure may include databases and real-time network connections. This makes it difficult and expensive to deploy biometric solutions in many locations.

What is needed is a method and an apparatus for low-cost identification authentication that is non-subjective, scalable, secure, and ultra portable.

### SUMMARY

One embodiment of the present invention provides a system for authenticating and individual's identity. The system operates by receiving an identification credential from the individual, such as an ID card, that contains information about the individual including biometric data. This ID card is digitally signed with a private key as used in public key cryptography systems which are commonly known as PKI. The system also receives a biometric sample from the individual, such as a finger print. The system validates the identification credential with the corresponding public key and compares the biometric data with the biometric sample. If the difference between the data and the sample is below a predetermined threshold, the system reports a positive identification. Otherwise, the system reports a negative identification. Note that the system operates solely on information contained within the identification credential and without requiring a connection to a network or a database.

In one embodiment of the present invention, a user can adjust the predetermined threshold value.

In one embodiment of the present invention, the identification credential can include a name, a unique ID, a citizenship, an issue date, an expiration date, an identifier for an issuing authority, the biometric data, and a digital photo.

In one embodiment of the present invention, the biometric sample can include one of, or a combination of, a fingerprint, a signature, an iris scan, a facial scan, a voice pattern, a height, a weight, and a palm scan.

In one embodiment of the present invention, the digitally signed biometric data is contained in one of a magnetic stripe, a bar code, a smart card, a chip-card, and a non-volatile memory, such as flash memory, located on or within the identification credential.

In one embodiment of the present invention, the digital signature is provided by a central certification authority.

In one embodiment of the present invention, the system grants access to resources, such as unlocking a door or boarding a plane, based on the determination if the difference between the digitally signed biometric data and the biometric data from the individual is below the predetermined threshold.

### BRIEF DESCRIPTION OF THE FIGURES

FIG. 1 illustrates an identification authentication device in accordance with an embodiment of the present invention.

FIG. 2 is a flowchart illustrating the process of identification authentication in accordance with an embodiment of the present invention.

FIG. 3 is a flowchart illustrating the process of verifying a digital signature in accordance with an embodiment of the present invention.

FIG. 4 is a flowchart illustrating the process of creating an identification credential in accordance with an embodiment of the present invention.

Table 1 provides an exemplary set of data stored in an identification credential in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, EPROMs, flash memory, smart cards, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Identification Authentication Device

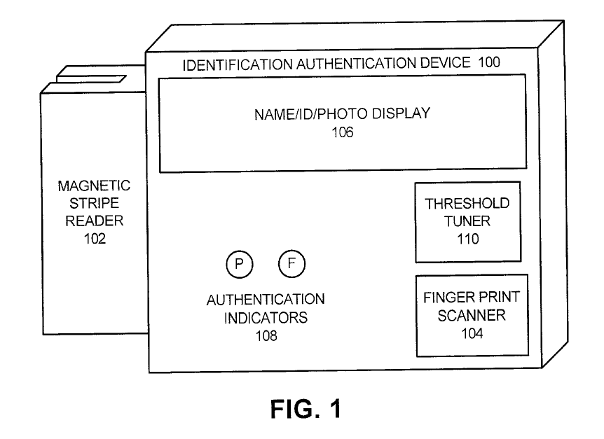

FIG. 1 illustrates an identification authentication device in accordance with an embodiment of the present invention. Identification authentication device 100 contains a magnetic stripe reader 102 and a finger print scanner 104. Note that magnetic stripe reader 102 could also be a bar code reader, a flash memory reader, a smartcard or a chip reader, or any other device that can retrieve data from a non-volatile memory source. Also note that finger print scanner 102 could be any type of biometric input device including, but not limited to, a microphone, a palm scanner, a signature recognition device, and a camera.

Identification authentication device 100 also contains display 106 for supplying feedback to the user such as a name. ID number, or photo of the individual for whom the identification credential belongs. Additionally, identification authentication device 100 contains threshold tuner 110 which allows the user to preset the level of security of identification authentication device 100. The biometric sample provided by the user and the biometric data contained on the identification credential, even if from the same individual, will usually not create a 100 percent match. A threshold tuning device is desirable as it allows for more restrictive and accurate identification authentication in higher security areas.

Finally, identification authentication device has authentication indicators 108 to display the result of the identification authentication. The final value of the authentication comparison could also be displayed on display 106 allowing for an individual to make the final authentication decision. Note that the identification authentication device 100 can be connected to many different devices to control access to various resources such as access to restricted areas such as nuclear facilities or boarding aircraft, entrance to events, ATM machines, or electronic voting systems.

Identification authentication system 100 is designed to operate without the need for a network connection or a connection to a database. However, identification authentication device 100 could be connected to a network or database to allow for greater functionality such as notification of a revoked identification credential or reporting authentication logs.

Identification Authentication Process

TABLE 1

| | |
|---|---|
| Name | John Smith |
| Unique ID | 1234-3212-4567-9875 |
| Citizenship | USA |
| Issue Date | 01 Oct. 2001 |
| Expiration Date | 30 Sep. 2010 |
| Issuing Authority | US National ID Card Office |
| Biometric Data | 05 A2 B6 4F . . . |
| Digital Photo | GTE file |
| Digital Signature Format | RSA/PKCS7 |
| Digital Signature Data | 3x4cd3A5hj3h5 . . . |

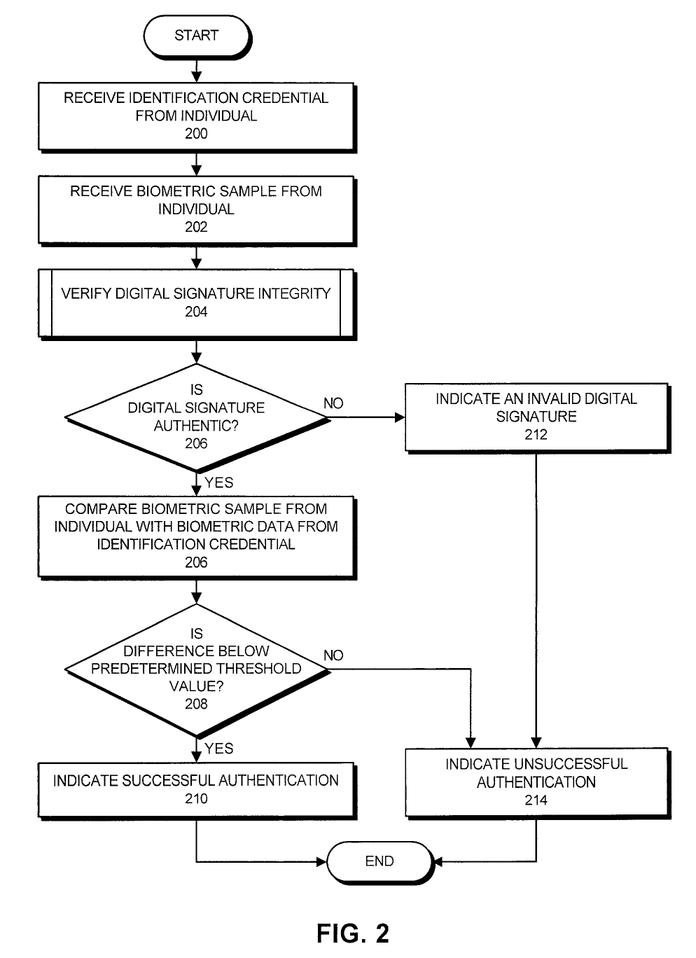

FIG. 2 is a flowchart illustrating the process of identification authentication in accordance with an embodiment of the present invention. First, identification authentication device 100 receives an identification credential from an individual, usually in the form of an ID card (step 200). Table 1 above illustrates typical data found within the identification credential.

Next, identification authentication device 100 receives a biometric sample from the individual, such as a finger print (step 202). Then, identification authentication device 100 verifies the integrity of the digital signature contained on the identification credential (step 204). If the signature is not valid, identification authentication device 100 indicates the invalid signature (step 212) and indicates unsuccessful authentication (step 214). Identification authentication device 100 could additionally be configured to revoke or destroy the identification authentication credential. If the digital signature is valid, identification authentication device 100 compares the biometric sample from the individual with the biometric data from the identification credential (step 206). If the difference between the data and the sample are below the predetermined threshold, then identification authentication device 100 indicates successful authentication (step 210). If the difference between the data and the sample are not below the predetermined threshold, then identification authentication device 100 indicates unsuccessful authentication (step 214).

Digital Signature Verification

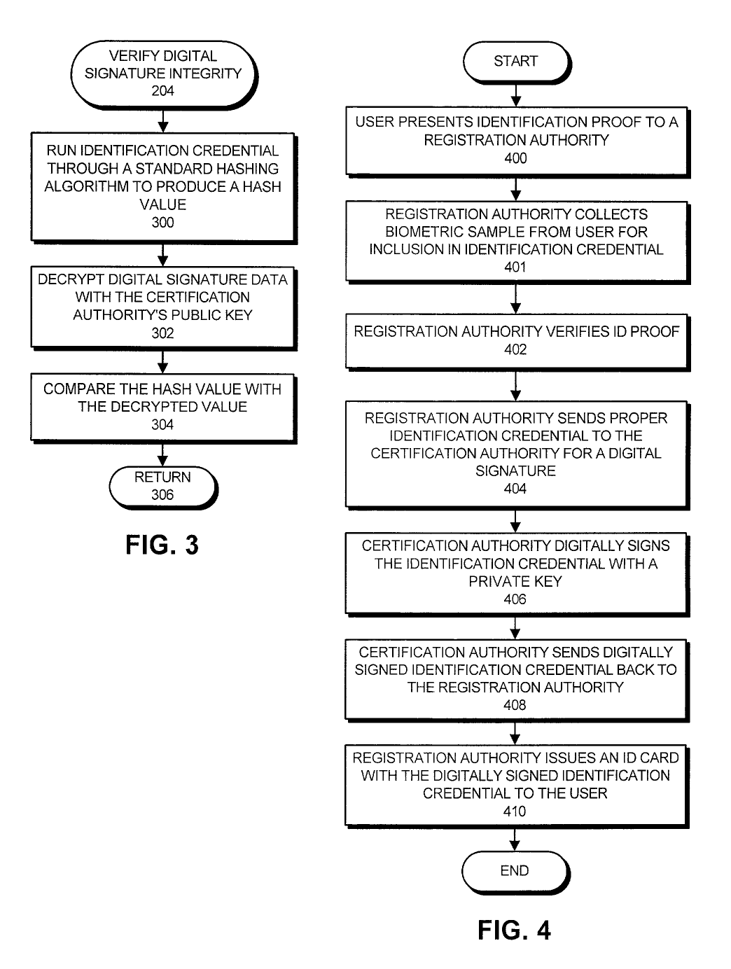

FIG. 3 is a flowchart illustrating the process of verifying a digital signature in accordance with an embodiment of the present invention. Identification authentication device 100 verifies the integrity of the digital signature by utilizing industry standard PKI practices. First the data from the identification credential is run through a standard hashing algorithm to produce a hash value for the data (step 300). Next, the digital signature data is decrypted with one of the stored Certification Authority's public key (step 302). Finally, the decrypted value and the hash value are compared for an exact match (step 304), and the results are returned to identification authentication device 100 (step 306).

Process of Creating an Identification Credential

FIG. 4 is a flowchart illustrating the process of creating an identification credential in accordance with an embodiment of the present invention. First, a user presents identification proof such as a birth certificate and a passport to a Registration Authority such as a DMV or a Post Office (step 400). At this time, the Registration Authority also collects one or more biometric samples from the user, such as a fingerprint scan, for inclusion in the identification credential (step 401). Next, the Registration Authority verifies the identification proof (step 402) and forwards the identification credential to the Certification Authority for a digital signature (step 404). Then, the Certification Authority digitally signs the identification credential with a private key (step 406) and returns the digitally signed credential back to the Registration Authority (step 408). Finally, the Registration Authority issues the digitally signed identification credential to the users, usually in the form of an ID card (step 410).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for providing identification authentication, comprising:
receiving an identification credential from an individual, including a biometric data, wherein the identification credential is digitally signed with a private key;
receiving a biometric sample from the individual;
validating the digital signature using a corresponding public key;
determining if a difference between the digitally signed biometric data and the biometric data from the individual is below a predetermined threshold; and
providing the results of the determination to an interested party;
whereby the identity of the individual can be authenticated with reference to the identification credential alone, without having to lookup information for the individual in a database.

2. The method of claim 1, further comprising adjusting the predetermined threshold in accordance with instructions received from a user.

3. The method of claim 1, wherein the identification credential can include a name, a unique ID, a citizenship, an issue date, an expiration date, an identifier for an issuing authority, the biometric data, and a digital photo.

4. The method of claim 1, wherein the biometric sample can include one of, or a combination of, a fingerprint, a signature, an iris scan, a facial scan, a voice pattern, a height, a weight, or a palm scan.

5. The method of claim 1, wherein the digitally signed biometric data is contained in a magnetic stripe, a bar code, a smart card, a chip-card, or a non-volatile memory, such as flash memory, located on or within the identification credential.

6. The method of claim 1, wherein the digital signature is provided by a central certification authority.

7. The method of claim 1, further comprising granting access to resources based on the determination if the difference between the digitally signed biometric data and the biometric data from the individual is below the predetermined threshold.

8. A computer-readable storage medium storing instructions that when executed by a computer cause the computer to perform a method for providing identification authentication, the method comprising:
receiving an identification credential from an individual, including a biometric data, wherein the identification credential is digitally signed with a private key;
receiving a biometric sample from the individual;
validating the digital signature using a corresponding public key;
determining if a difference between the digitally signed biometric data and the biometric data from the individual is below a predetermined threshold; and
providing the results of the determination to an interested party;
whereby the identity of the individual can be authenticated with reference to the identification credential alone, without having to lookup information for the individual in a database.

9. The computer-readable storage medium of claim 8, wherein the method further comprises adjusting the predetermined threshold in accordance with instructions received from a user.

10. The computer-readable storage medium of claim 8, wherein the identification credential can include a name, a unique ID, a citizenship, an issue date, an expiration date, an identifier for an issuing authority, the biometric data, and a digital photo.

11. The computer-readable storage medium of claim 8, wherein the biometric sample can include one of, or a combination of, a fingerprint, a signature, an iris scan, a facial scan, a voice pattern, a height, a weight, or a palm scan.

12. The computer-readable storage medium of claim 8, wherein the digitally signed biometric data is contained in a magnetic stripe, a bar code, a smart card, a chip-card, or a non-volatile memory, such as flash memory, located on or within the identification credential.

13. The computer-readable storage medium of claim 8, wherein the digital signature is provided by a central certification authority.

14. The computer-readable storage medium of claim 8, wherein the method further comprises granting access to resources based on the determination if the difference between the digitally signed biometric data and the biometric data from the individual is below the predetermined threshold.

15. An apparatus for providing identification authentication, comprising:
a receiving mechanism that is configured to receive an identification credential from an individual, including a biometric data, wherein the identification credential is digitally signed with a private key;
a sampling mechanism that is configured to receive a biometric sample from the individual;
a validation mechanism that is configured to validate the digital signature using a corresponding public key;
a determination mechanism that is configured to determine if a difference between the digitally signed biometric data and the biometric data from the individual is below a predetermined threshold; and
a feedback mechanism that is configured to provide the results of the determination to an interested party;
whereby the identity of the individual can be authenticated with reference to the identification credential alone, without having to lookup information for the individual in a database.

16. The apparatus of claim 15, further comprising an adjustment mechanism configured to adjust the predetermined threshold in accordance with instructions received from a user.

17. The apparatus of claim 15, wherein the identification credential can include a name, a unique ID, a citizenship, an issue date, an expiration date, an identifier for an issuing authority, the biometric data, and a digital photo.

18. The apparatus of claim 15, wherein the biometric sample can include one of, or a combination of, a fingerprint, a signature, an iris scan, a facial scan, a voice pattern, a height, a weight, or a palm scan.

19. The apparatus of claim 15, wherein the digitally signed biometric data is contained in a magnetic stripe, a bar code, a smart card, a chip-card, or a non-volatile memory, such as flash memory, located on or within the identification credential.

20. The apparatus of claim 15, wherein the digital signature is provided by a central certification authority.

21. The apparatus of claim 15, further comprising a security mechanism configured to grant access to resources based on the determination if the difference between the digitally signed biometric data and the biometric data from the individual is below the predetermined threshold.
